(19) United States
(12) Patent Application Publication
(10) Pub. No.: US 2022/0342146 A1
(43) Pub. Date: Oct. 27, 2022

(54) COUPLING LOSS REDUCTION BETWEEN OPTICAL FIBERS

(71) Applicant: OFS Fitel, LLC, Norcross, GA (US)

(72) Inventors: Matt Corrado, Davis, CA (US); Brian Mangan, Hopewell, NJ (US); Tristan Kremp, Somerset, NJ (US)

(73) Assignee: OFS Fitel, LLC, Norcross, GA (US)

(21) Appl. No.: 17/636,890

(22) PCT Filed: Aug. 21, 2020
(86) PCT No.: PCT/US20/47529

§ 371 Date: Feb. 20, 2022

Related U.S. Application Data
(60) Provisional application No. 62/889,882, filed on Aug. 21, 2019.

(51) Int. Cl. G02B 6/02; G02B 6/26

(52) U.S. Cl. CPC G02B 6/02328; G02B 6/262

(57) ABSTRACT

Described herein are systems, methods, and articles of manufacture for reducing coupling loss between optical fibers, more particularly, to reducing coupling loss between a hollow-core optical fiber (HCF) and another fiber, such as solid core fibers (SCF), through the use of mismatched mode field diameter (MFD). According to one embodiment, an article is configured to reduce a coupling loss between multiple optical fibers, wherein the article includes an HCF supporting the propagation of a first mode and an SCF coupled to the HCF. According to a further embodiment, a method is described for reducing the coupling loss or splicing loss between optical fibers, such as an exemplary HCF and a solid core SMF. These exemplary methods may include coupling/splicing an exemplary HCF to an exemplary SMF with significantly smaller MFD.

### CROSS-REFERENCE TO RELATED APPLICATIONS

This application claims the benefit of U.S. Provisional Application No. 62/889,882, filed Aug. 21, 2019, and herein incorporated by reference.

### TECHNICAL FIELD

Described herein are systems, methods, and articles of manufacture for reducing coupling loss between optical fibers, more particularly, to reducing coupling loss between a hollow-core optical fiber (HCF) and another fiber, such as a solid core fiber (SCF), through the use of mode field diameter (MFD) mismatch.

### BACKGROUND OF THE INVENTION

Hollow-core optical fiber is a powerful technology platform offering breakthrough performance improvements in sensing, communications, higher-power optical pulse delivery, and the like. Indeed, since its latency is almost equal to the propagation of an optical wave in a vacuum, the hollow-core optical fiber offers an attractive solution for data centers, high-frequency stock trading communication links, distributed computing environments, high-performance computing, etc. In the stock trading application, for example, the hollow-core optical fiber is contemplated as allowing for decreased data transmission times between trading computers, enabling trading programs to complete programmed trading transactions more quickly.

A hollow core fiber is defined here as any fiber that has a core that is not solid, such as a hollow core that can be a vacuum or filled with a gas, such as air. In this disclosure, a hollow core fiber with a photonic band gap cladding is exemplified but the coupling loss between any hollow core fiber can be reduced by the methods explained herein. Typically hollow core fibers have a larger core diameter than standard solid core optical fibers to reduce the amount of light that overlaps with the air/glass interfaces at the edge of the core that is the dominant cause of loss in the fiber.

In an optical setup or system that takes advantage of the desirable properties of hollow-core fiber such as low latency, temperature independence, radiation hardness, etc., the HCF usually needs to be coupled at one or several points to standard optical components that are designed for standard commercially available SCF, typically solid core single-mode fiber (SMF). Thus, a need remains in the art for minimizing the coupling loss of these connections or splices, as these connections are often crucial for the best possible performance of the system. Since the transverse profile of the fundamental modes of the HCF can differ substantially from the fundamental mode of an SMF, it is unclear what is the best MFD ratio in both fibers to achieve a minimum coupling loss.

### SUMMARY OF THE INVENTION

The present invention addresses the needs in the art and is directed to reducing the coupling or splicing loss in connections that include a hollow-core optical fiber. For instance, the coupling loss or splicing loss between an HCF and an SMF may be minimized by choosing an SMF with an MFD that is significantly smaller than the MFD of the HCF.

In accordance with one or more embodiments of the present invention, an article of manufacture is described herein that is configured to reduce a coupling loss between multiple optical fibers, wherein the article of manufacture includes a hollow-core fiber HCF supporting the propagation of a first mode and an SCF coupled to the HCF.

An exemplary embodiment of the present invention takes the form of a method, such as: coupling/splicing an exemplary HCF to an exemplary SMF with significantly smaller MFD; coupling/splicing an HCF to an SMF by inserting a third fiber with an MFD that is between the MFD of the HCF and the MFD of the SMF; coupling/splicing an HCF to an SMF that is tapered at its end; coupling/splicing an HCF to an SMF that has a longitudinally varying concentration of dopants at its end, etc.

Other and further embodiments and aspects of the present invention will become apparent during the course of the following discussion and by reference to the accompanying drawings.

### BRIEF DESCRIPTION OF THE DRAWINGS

Referring now to the drawings:

FIG. 1 is a diagram depicting the fundamental mode in an exemplary 19-cell HCF with 6 outer cores (shunts) in accordance with one embodiment of the present invention;

FIG. 2A illustrates the wavelength dependence of the modal properties of the exemplary HCF in FIG. 1 based on mode mismatch contributions to splice loss for various SMF MFD;

FIG. 2B illustrates the wavelength dependence of the modal properties of the exemplary HCF in FIG. 1 based on the MFD of the exemplary HCF in FIG. 1;

FIG. 3 illustrates the relationship of the optimum MFD ratio vs. normalized core size of an exemplary HCF;

FIG. 4 illustrates the relationship of the optimum SMF MFD vs. HCF core size of an exemplary HCF in accordance with one embodiment of the present invention.

### DETAILED DESCRIPTION

As will be discussed in detail below, the present invention relates to assessing the properties of various types of couplings and splices between hollow-core optical fibers and other fibers to minimize the coupling loss. For example, the transmission of optical signal light along an “air” core (as is the case for various configurations of hollow-core fiber) provides for transmission speeds that are 30% greater than that associated with standard silica core optical fibers. As mentioned above, this feature has particular applications to high-frequency trading companies, which rely on low latency communication links. Low latency also has applications in datacenter/supercomputer applications, where hundreds of kilometers of optical cables are used to interconnect thousands of servers. As discussed above, one embodiment of the invention allows for the coupling loss or splicing loss between an HCF and an SMF to be minimized by choosing an SMF with an MFD that is significantly smaller than the MFD of the HCF.

Furthermore, according to a further embodiment of the present invention, it may be advantageous to add a short section of a third fiber, referred to as a mode field adaptation fiber (MFAF) here, between the SMF and the HCF to minimize the overall coupling loss.

In a logarithmic (decibel) scale, the total coupling or splicing loss α^{(dB)} between an HCF and an SMF is the sum of two terms according to:

$${α}^{( dB )} = {\underbrace{- 10 {log}_{10} ( 1 - {( \frac{{n}_{SMF}^{eff} - {n}_{HCF}^{eff}}{{n}_{SMF}^{eff} + {n}_{HCF}^{eff}} )}^{2} )}}_{\text{=:} {α}_{Fresnel}^{( dB )}} {\underbrace{- 10 {log}_{10} ( {max}_{MFD} {max}_{{x}_{0} , {y}_{0}} {max}_{φ ∈ [ 0 , 2 π )} \frac{{\vert ( {E}_{SMF} , {E}_{HCF} ) \vert}^{2}}{( {E}_{SMF} , {E}_{SMF} ) ( {E}_{HCF} , {E}_{HCF} )} )}}_{\text{=:} {α}_{mode mismatch}^{( dB )}} .$$

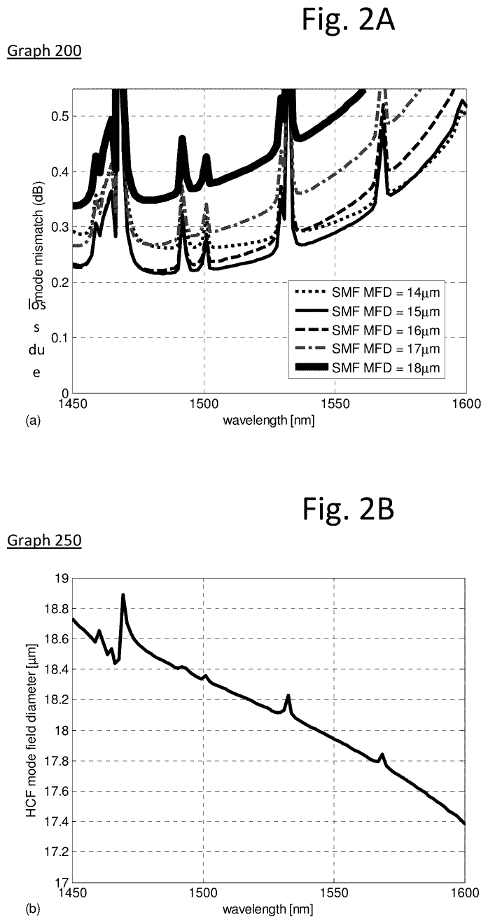

The first term α_{Fresnel}^{(dB)} is the unavoidable Fresnel reflection because of the substantially different effective indices. At a wavelength of 1550 nm, there may typically be n_{SMF}^{eff}=1.45 and n_{HCF}^{eff}=1, leading to α_{Fresnel}^{(dB)}=0.15 dB. To avoid that the Fresnel-reflected light is backward-propagated along the fiber, which would cause unwanted noise in the system, the splice can be angled relative to the fiber cross section. The second term α_{mode mismatch}^{(dB)} (see FIG. 2A) is due to the mismatch of the fundamental modes in the two fibers, approximated by transverse overlap integrals of the (electrical) fields E_{HCF} in the HCF and E_{SMF} in the SMF, using the notation of the symmetric sesquilinear form: (U, V):=∫_{A} (Uₓ(x, y)Vₓ*(x, y)+U_{y} (x, y)V_{y}*(x, y)+U_{z}(x, y)V_{z}*(x, y))dA of two vector fields U,V over the transverse area A that is typically the fiber cross-section.

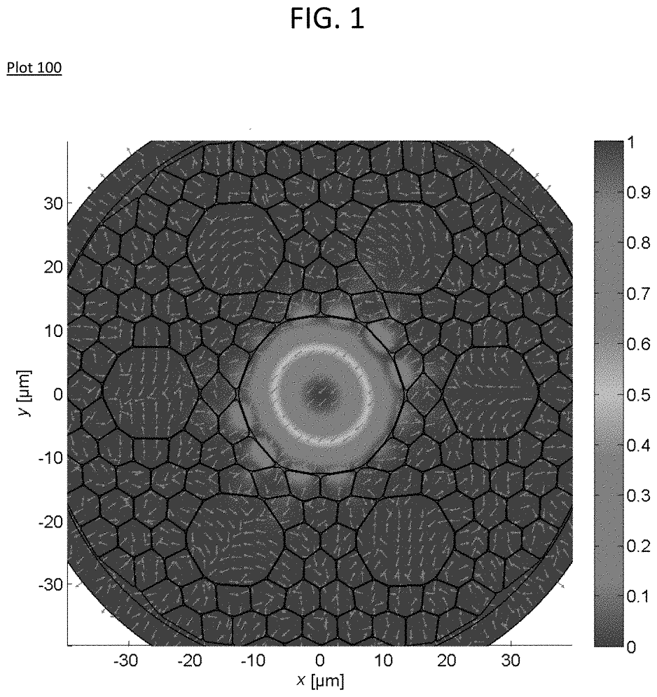

To minimize the coupling loss, the fundamental mode of the SMF may have a relatively small overlap with the core wall region of the HCF. FIG. 1 illustrates a plot 100 of the fundamental mode in an exemplary 19-cell HCF with six outer cores (e.g., shunts). The arrows indicate the local direction of the electric field, and the shading indicates the square root of the optical intensity. While the exemplary HCF used in FIG. 1 is a 19-cell HCF, alternative embodiments of the present invention are not limited to this structure and allow for variations to the HCF, using any number of cells and outer cores, including, but not limited to, the case of having no outer cores, i.e., a single-core HCF.

It is important to note that the direction of the electric (and magnetic) field of the fundamental mode of the HCF is strongly position-dependent in this core wall region of the HCF (see FIG. 1). In contrast, an exemplary SMF may typically usually have a fundamental mode with a more uniformly oriented electric (and magnetic) field. Such a reduced overlap with the core wall region is achieved if the SMF has an MFD that is smaller than the MFD of the HCF.

However, making the MFD of the SMF too small may also lead to an increase in the coupling loss. As an example, graph 200 of FIG. 2A shows the mode mismatch loss (splicing or coupling loss minus Fresnel reflection loss) from an SMF with a Gaussian mode shape to the HCF from FIG. 1. At a wavelength of 1550 nm, a minimum mode mismatch loss of about 0.29 dB can be achieved by using an SMF with an MFD of about 15 μm. This is only about 83% of the MFD of the HCF, which is about 18 μm at 1550 nm, see graph 250 FIG. 2B. In contrast, if an SMF with an MFD of 18 μm at 1550 nm had been chosen (thick line in FIG. 2A), the mode mismatch loss would be about 0.5 dB, i.e., 0.21 dB higher than the optimum loss. According to one embodiment of the present invention, the MFD of an exemplary SMF may be no greater than 85% of an MFD of the exemplary HCF. According to alternative embodiments of the present invention, the MFD of an exemplary SMF may be no greater than 90% of an MFD of the exemplary HCF.

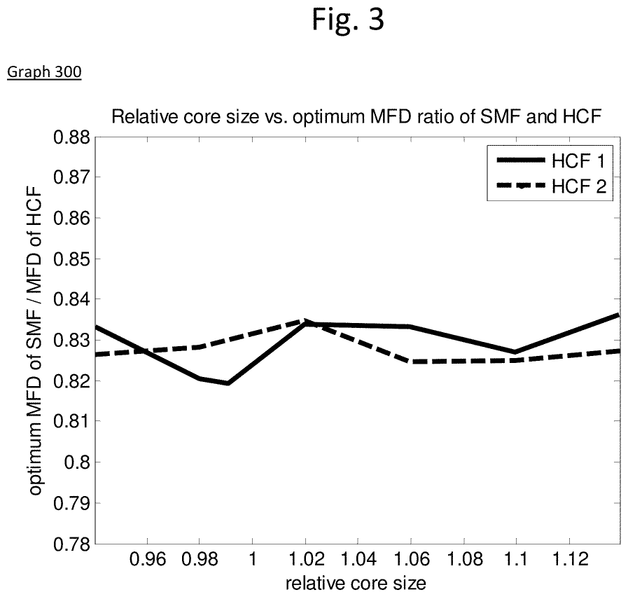

The fact that the optimum SMF MFD is significantly smaller than the MFD of the HCF holds over a large range of HCF core diameters and even different HCF designs. For example, graph 300 of FIG. 3 shows the optimum MFD ratio (optimum SMF MFD divided by MFD of the HCF) as a function of the relative core size d_{core,rel} of the HCF, which is defined as

$${d}_{core , rel} := \frac{{d}_{core}}{5 \cdot P}$$

with the absolute core diameter d_{core} and the pitch P of the microstructure, which, as those skilled in the art know, is the average diameter of the cells in the microstructure. The two fibers HCF 1 and HCF 2 differ in a number of features, such as, for instance, air filling fraction, d_{core}, production date, etc. Nevertheless, in both cases, the optimum MFD ratio is constantly around 83%.

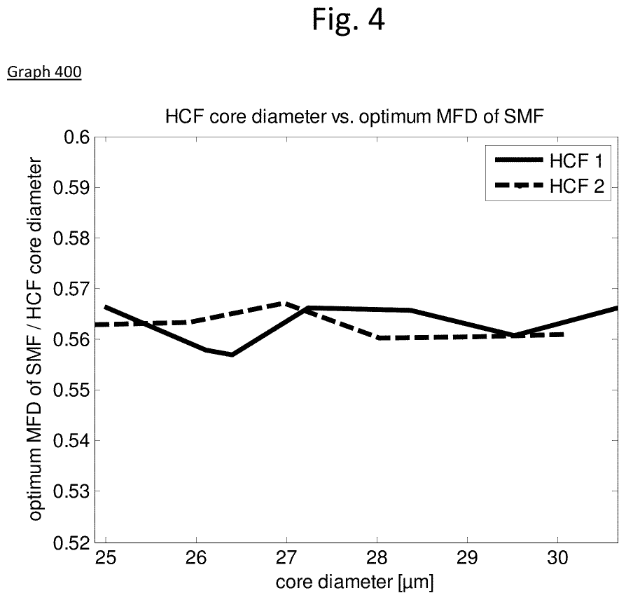

Accordingly, FIG. 3 normalizes the optimum MFD of the SMF in terms of a modal property of the HCF, namely its MFD, which may be hard to measure. In addition, FIG. 4 normalizes in terms of the much easier to measure core diameter. The graph 400 in FIG. 4 illustrates the relationship between the SMF MFD and the HCF core size. In these units, the optimum MFD of the SMF is about 56% of the core diameter of the HCF, again over a large range of HCF core diameters and for both HCF 1 and HCF 2. According to one embodiment of the present invention, the MFD of an exemplary SMF may be no greater than 58% of the core diameter of an exemplary HCF. According to an alternative embodiment of the present invention, the MFD of an exemplary SMF may be no greater than 61% of the core diameter of an exemplary HCF.

As noted above, it may be advantageous to use a third fiber (typically a short section) between an exemplary SMF and an exemplary HCF in order to further reduce the coupling or splicing loss. Thus, a single change of the MFD may be replaced by two smaller changes in the MFD. More generally, one or more fibers or waveguides (typically short sections) may be used between the SMF and the HCF to achieve an even more gradual change of the MFD. According to an alternative embodiment, a taper may be used with a continuous variation of the MFD along its length.

To further reduce the mode mismatch and splicing or coupling loss, various dopants and doping profiles (e.g., varying refractive indices) may be used at the tip of the exemplary SMF, and/or gases, liquids, or solids may be included in the core or cores or cladding cells of the exemplary HCF. Furthermore, according to an alternative embodiment of the present disclosure, there may be an angle splice between the HCF and SMF to increase the return loss.

Further aspects of the present invention relate to methods for reducing the coupling loss or splicing loss between optical fibers, such as an exemplary HCF and an SMF. These exemplary methods may include, but are not limited to: coupling/splicing an exemplary HCF to an exemplary SMF with significantly smaller MFD; coupling/splicing an HCF to an SMF by inserting a third fiber with an MFD that is between the MFD of the HCF and the MFD of the SMF; coupling/splicing an HCF to an SMF that is tapered at its end; coupling/splicing an HCF to an SMF that may have a longitudinally varying concentration of dopants at its end, longitudinally varying the refractive index at its end, etc.

The exemplary embodiments described throughout this specification are not only applicable to HCFs but may also be applied to other types of microstructured fibers as well as more generally to fibers with a fundamental mode that has a transverse shape that is different from the transverse shape of the fundamental mode of a typical SMF.

Throughout this specification, the term “SMF” may refer to a solid-core SMF. However, those skilled in the art would understand that SMF may also refer to a different type of SMF, such as, for example, a hollow core single mode fiber.

The present disclosure has been described with reference to exemplary embodiments thereof. All exemplary embodiments and conditional illustrations disclosed in the present disclosure have been described to intend to assist in the understanding of the principle and the concept of the present disclosure by those skilled in the art to which the present disclosure pertains. Therefore, it will be understood by those skilled in the art to which the present disclosure pertains that the present disclosure may be implemented in modified forms without departing from the spirit and scope of the present disclosure. Although numerous embodiments having various features have been described herein, combinations of such various features in other combinations not discussed herein are contemplated within the scope of embodiments of the present disclosure.

What is claimed is:

1. An article configured to reduce a coupling loss between multiple optical fibers, including:
a hollow-core fiber (HCF) having a first mode field diameter (MFD); and
an additional fiber coupled to the HCF, wherein the additional fiber has a second MFD that is no greater than 90% of the first MFD.

2. The article described in claim 1, wherein the additional fiber is a solid core fiber.

3. The article described in claim 1, wherein the additional fiber is a single-mode fiber.

4. The article described in claim 1, wherein the additional fiber comprises a longitudinally varying refractive index.

5. The article described in claim 1, further including a further short fiber having a third MFD and positioned between the HCF and additional fiber, wherein the third MFD is smaller than the first MFD and greater than the second MFD.

6. The article described in claim 1, further including a tapered portion providing a gradual transition from the first MFD to the second MFD.

7. The article described in claim 1, further including an angle splice between the HCF and SMF to increase the return loss.

8. An article configured to reduce a coupling loss between multiple optical fibers, including:
a hollow-core fiber (HCF) having a core and a core wall region; and
an additional fiber coupled to the HCF, wherein the additional fiber propagates a fundamental mode in a region that is no greater than 61% of a diameter of the core wall region of the HCF.

9. The article described in claim 8, wherein the additional fiber is a solid core fiber.

10. The article described in claim 8, wherein the additional fiber is a single-mode fiber.

11. The article described in claim 8, wherein the additional fiber comprises a longitudinally varying concentration of dopants.

12. The article described in claim 8, further including a further short fiber having a third MFD and positioned between the HCF and the additional fiber, wherein the third MFD is smaller than the first MFD and greater than the second MFD.

13. The article described in claim 8, further including a tapered portion providing a gradual transition from the first MFD to the second MFD.

14. A method of configuring an article to reduce a coupling loss between multiple optical fibers, including:
coupling a hollow-core fiber (HCF) having a first MFD to an additional fiber, wherein the additional fiber has one of:
a second MFD that is no greater than 90% of the first MFD; or
a fundamental mode propagation region that is no greater than 61% of a diameter of a core wall region of the HCF.

15. The method described in claim 14, wherein the additional fiber is a solid core fiber.

16. The method described in claim 14, wherein the additional fiber is a single-mode fiber.

17. The method described in claim 14, wherein the additional fiber comprises a longitudinally varying concentration of dopants.

18. The method described in claim 14, further including:
coupling a further short fiber having a third MFD between the HCF and additional fiber, wherein the third MFD is smaller than the first MFD and greater than the second MFD.

19. The method described in claim 14, wherein the additional fiber coupled to the HCF includes a tapered portion providing a gradual transition from the first MFD to the second MFD.

20. The method described in claim 14, wherein the coupling of the HCF and SMF includes an angle splice to increase the return loss.
